(19) United States
(12) Patent Application Publication
(10) Pub. No.: US 2003/0115769 A1
(43) Pub. Date: Jun. 26, 2003

(54) Rotary dryer

(76) Inventors: Jia-Hung Huang, Hsinchu (TW); Jia-Ming Huang, Hsinchu (TW); Churng-Kwang Lai, Hsinchu (TW); Chi-Ming Tsai, Hsinchu (TW); Jsan-Yan Chang, Hsinchu (TW); Cheng-Che Chen, Taichung (TW); Jui-Chin Teng, Taoyuan (TW); Yao-Ling Huang, Hsinchu (TW); Shann-Shiuann Tzeng, Hsinchu (TW)

Correspondence Address: BIRCH STEWART KOLASCH & BIRCH, PO BOX 747, FALLS CHURCH, VA, 22040-0747, US

(21) Appl. No.: 10/183,642

(22) Filed: Jun. 28, 2002

(30) Foreign Application Priority Data
Dec. 20, 2001 (TW) 90222436

(51) Int. Cl. F26B 11/02; D06F 58/00

(52) U.S. Cl. 34/134; 34/135

(57) ABSTRACT

A rotary dryer. The dryer includes a rotary drum and a dehumidifier. the rotary cylinder receives dry air and wet material, wherein The wet material is rotated by the rotary drum to completely contact the dry air so that The wet material changes to grains. the dehumidifier receives wet air from the rotary drum, dehumidifies the wet air, and introduces dry air to the rotary cylinder.

### BACKGROUND OF THE INVENTION

1. Field of the Invention

The present invention relates to a dryer, particularly relates to a rotary dryer that granulates wet material.

2. Description of the Prior Art

Material dehydration technology methods include hot-wind dehydration, radiating dehydration, dehumidifying dehydration, and others. Basically, hot-wind and radiating dehydration methods work by utilizing the temperature differences between the dehydrating medium and the material. the dehumidifying dehydration method works by utilizing the humidity difference between the dehydrating medium and the material. Regardless of which method is applied, higher energy efficiency demands increased contact area between the material and the dehydrating medium.

For the dehydration chamber inside a dehydration machine, i.e. the dryer, there have been various types of structures proposed. Taiwan Patent No. 73210414 proposes a simple structure of dehydration chamber. the chamber is composed of a barrel and an apertured-taper base. Dry air is introduced into the barrel via the apertured-taper base and contacts the material, removing the water therefrom. However, the prior art has a disadvantage in that the contact between the dry air and the material is not sufficient, therefore the dehydration effect is reduced, and the energy efficiency is low.

Another type of dehydration chamber is proposed in Taiwan Patent No. 085211729. the chamber is comprised of a barrel and a rotation shaft comprising a plurality of partitions. Each of the partitions comprises a gap. In operation, dry air is introduced via the bottom of the barrel. By means of the partitions, the material is dehydrated by the dry air layer by layer. This design may improve the contact between the material and the dry air. However, the design still has a disadvantage in that the dry air might alter its flow route, reducing the dehydration efficiency.

Taiwan Patent No. 76101064, proposes an apparatus, which includes dehydration and granulation. However, the structure of this design is very complicated, and the system requires a high temperature of 800° F. Moreover, the structure is an exposed system, such that additional equipment is required to prevent pollution from the dehydrated material.

As to the commonly-used sludge dehydrating apparatuses, most of the equipment is operated by applying hot-wind method or electric heating method. the dehydration of the sludge produces moisture. Because dehydration machines are not regulated, most of this kind of equipments is designed to release moisture directly into the atmosphere, which easily produces foul smells, and may introduce severe levels of pollutant into the environment.

### SUMMARY OF THE INVENTION

The present invention provides a rotary dryer adapted to increasing the contact area between dehydrated material and the dehydrating medium, and also the contact time thereof. the energy efficiency of the rotary dryer is improved.

Another purpose of the present invention to provide a rotary dryer granulating and filtering dehydrated material in operation, thereby producing material grains of improved dimensional uniformity.

Another purpose of the present invention is to provide a rotary dryer operating without production of exhaust gas, reducing pollutant emission.

The dryer of the present invention comprises a rotary drum and dehumidifying equipment. the rotary drum is adapted to contain dry air and material dehydrated, wherein the rotary drum rolls the material, thereby increasing the contact area between the material and the dry air, wherein the dry air absorbs moisture from the material, and the material is transformed into dehydrated material grains. the dehumidifying equipment receives and dehumidifies the wet air, and finally redirects the newly dry air into the rotary drum.

Accordingly, the present invention provides a closed-loop cycling procedure of material dehydration. the system operates without producing foul smells, producing only water.

### BRIEF DESCRIPTION OF THE DRAWINGS

The present invention can be fully understood from the following detailed description and preferred embodiment with reference to the accompanying drawings in which:

FIG. 1A is a schematic diagram illustrating the rotary dryer of the present invention.

FIG. 1B illustrates a right-end view of the rotary dryer of the present invention.

FIG. 2 shows a partition of the rotary dryer of the present invention.

FIG. 3 shows an apertured board of the rotary dryer of the present invention.

FIG. 4 illustrates a perspective view of the powder filtering apparatus disposed in the rotary dryer of the present invention.

FIG. 5 is a block diagram illustrating the operation of the rotary dryer of the present invention.

### DETAILED DESCRIPTION OF THE INVENTION

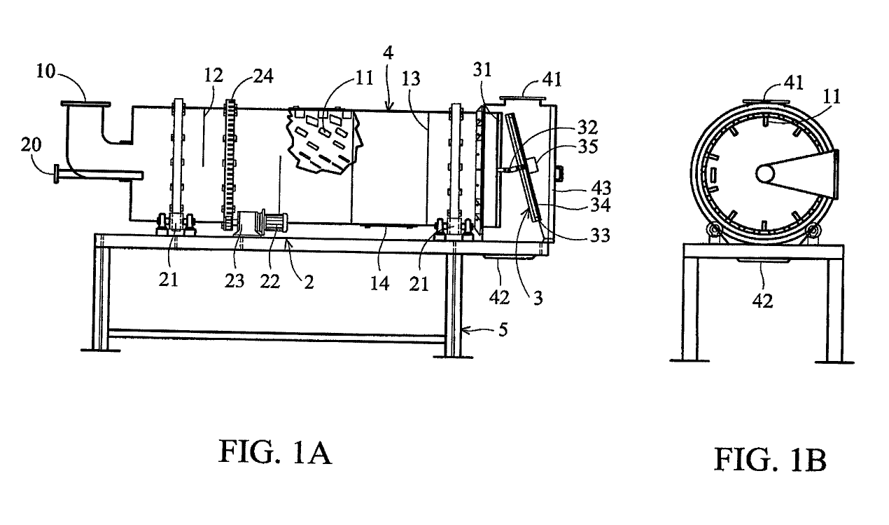

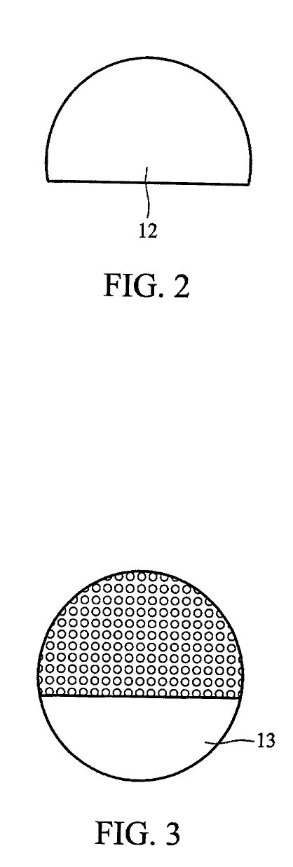

Refer to FIG. 1A and 1B. the dryer of the present invention us comprised of a fixing frame 5, a rotary drum 4, a powder filtering apparatus 3, and driving equipment 2. the rotary drum 4 is disposed on the fixing frame 5 via rolling wheels 21. the rotary drum 4 is comprised of a plurality of grasping boards 11, a plurality of partitions 12 (shown in FIG. 2), and an apertured board 13 (shown in FIG. 3). In operation, material to be dehydrated are introduced to the dryer from a material inlet 20, and dry air of high temperature is introduced from an air inlet 10. By means of the rotation of the rotary drum, the grasping boards stir the dehydrated material. the rotary drum 4 is divided into a plurality of chambers, whereby the dry air more substantially contacts the dehydrated material and absorbs the water therefrom. the now wet air is discharged from the air outlet 41. the volume of the material decreases, and the material is transformed into material balls via the rotation of the drum. the material balls then pass through the apertured board 13 and are released from a material outlet 42. the released material is collected by plastic bags, wagons, transporting belts or other carrying equipment. the apertured board 13, fixed in the rotary drum 4, is comprised of a plurality of round holes of a predetermined radius, only allowing the material balls smaller than the round holes to pass. the round holes cover substantially ½ to ⅔ of the area of the apertured board.

The ratio of the length to the diameter of the rotary drum is determined by the dehydrated material. if the dehydration of the material is difficult, a large ratio is required. Generally, the ratio is about 3 to 10. the drum 4 is comprised of a maintenance hole 14 so that the worker can maintain the drum conveniently. Furthermore, a cleaning door 43 is provided at the rear of the rotary drum to dismount, change and maintain a filtering net in the drum.

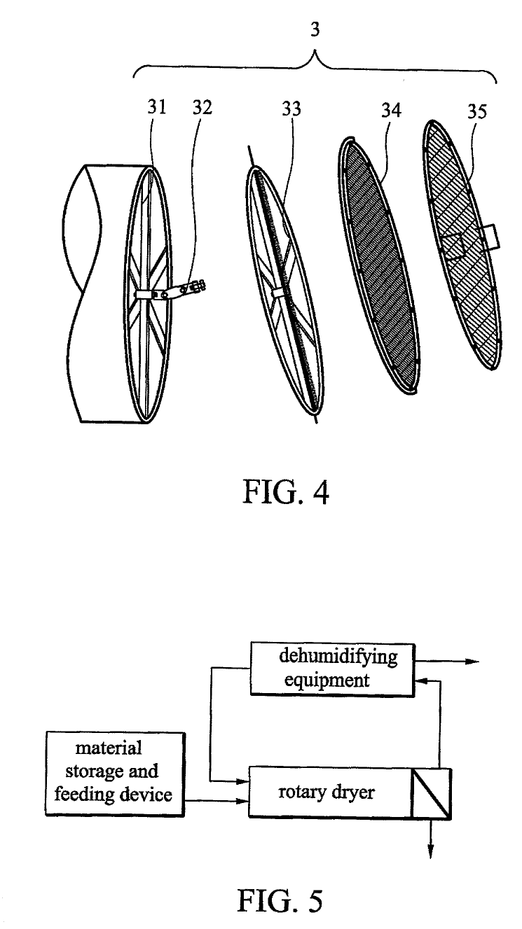

In FIG. 4. the powder filtering apparatus 3 is comprised of a transmission mechanism 31, a transmission shaft 32, a brush module 33, a filtering net 34, and a net supporting frame 35, the filtering net 34 and the net supporting frame 35 are fixed to the fixing frame 5 and are therefore stationary. In operation, the rotation of the rotary drum 4 drives the transmission mechanism 31, the transmission shaft 32 and the brush module 33. the brush module 33 has brush bristles closely contacting the filtering net 34. Powder adhering to the filtering net 34 then falls out from the material outlet 42 and is gathered together with the dehydrated material balls.

The driving equipment 2 is comprised of a driving motor 22, a reduction gear device 23 and a chain 24. A ring gear is disposed around the rotary drum 4 and is coupled with The chain 24, the driving motor 22 drives the rotary drum 4 via the ring gear and The chain 24. Furthermore, the rotating speed and direction of the driving motor 22 can be changed by means of a frequency converter.

FIG. 5 is a block diagram illustrating the operation of the rotary dryer of the present invention, wherein the dry air is provided from a dehumidifying equipment. An air outlet of the dehumidify equipment is couple with the air inlet of the rotary dryer, thereby providing a 40˜100° C.'s dry air to the rotary dryer. Furthermore, an air inlet of the dehumidifying equipment is coupled with the air outlet of the rotary dryer, whereby the wet air discharged from the rotary dryer is cooled in the dehumidify equipment to produce condensed water, the condensed water is transported to a wastewater processing station, or is directly discharged if the purity of the wastewater conforms to a predetermined standard.

The material inlet 20 is disposed at the front of the rotary drum 4 and is not rotatable. Therefore, the method of feeding material into the rotary dryer totally depends on the material. There is no need to adapt the rotary dryer and the dehydrating process of the present invention for the material. Furthermore, no waste gas is produced during the operation (only water is released). Therefore, use of the rotary dryer of the present invention does not pollute.

The dehumidifying equipment may be the combination of a heating apparatus, a heat sink apparatus and a dehumidifier applying a commonly-used coolant (e.g. R22 or R134a); or a combination of a heat sink apparatus and a dehumidifier applying a coolant adapted to high temperature such as R124. For cower conservation, however, the combination of a heat sink apparatus and the dehumidifier applying the coolant adapted to high temperature such as R124 is recommended. Such a combination saves more than ⅓ of the energy produced.

While the invention has been described with reference to a preferred embodiment, the description is not intended to be construed in a limiting sense. It is therefore contemplated that the appended claims will cover any such modifications or embodiments as may fall within the scope of the invention defined by the following claims and their equivalents.

What is claimed is:

1. A rotary dryer, comprising:
a rotary drum containing dry air and wet material, wherein the rotary drum rolls the wet material to improve contact between the wet material and the dry air, the dry air thereby absorbing water from the wet material and then being released from the rotary drum, the wet material thereby being transformed into material grains and powder;
a powder filtering apparatus filtering the powder; and
driving equipment rotating the rotary drum.

2. The rotary dryer of claim 1, further comprising at least one grasping board disposed on an inner surface of the rotary drum, thereby grasping and rolling the wet material as the rotary drum is rotated.

3. The rotary dryer of claim 1, further comprising at least one partition fixed in the rotary drum to partition the rotary drum into a plurality of chambers, wherein at least one partition guides the dry air to flow through the plurality of chambers.

4. The rotary dryer of claim 1, further comprising an apertured board disposed inside the rotary drum, wherein the apertured board defines a plurality of round apertures with a predetermined radius, thereby filtering the material grains and powder that are smaller than the plurality of apertures.

5. The rotary dryer of claim 4, wherein the plurality of apertures cover substantially ½ to ⅔ of the area of the apertured board.

6. The rotary dryer of claim 1, further comprising a fixing frame, with the rotary drum rotatably disposed thereon.

7. The rotary dryer of claim 6, wherein the powder filtering apparatus is comprised of:
a filtering net firmly disposed on the fixing frame, thereby filtering the powder; and
a brush module contacting the filtering net, wherein the brush module is coupled with the rotary drum, thereby removing the powder adhering to the filtering net as the rotary drum is rotated.

8. The rotary dryer of claim 7, wherein the brush module is comprised of bristle to brush out the powder adhering to the filtering net.

9. The rotary dryer of claim 8, wherein the bristle is metal bristle.

10. The rotary dryer of claim 8, wherein the bristle is animal bristle.

11. The rotary dryer of claim 8, wherein the bristle is plastic bristle.

12. A dryer, comprising:
a rotary drum receiving dry air and wet material, wherein the rotary drum rolls the wet material, thereby increasing contact between the wet material and the dry air; the dry air absorbing water from the wet material, and the wet material transformed into dry material grains; and
dehumidifying equipment receiving the wet air from the rotary drum, dehumidifying the wet air so that the wet air is transformed into the dry air, and providing the dry air to the rotary drum.

13. The dryer of claim 12, wherein the dry air provided by the dehumidifying equipment has a temperature of 40° C. to 100° C.
